(19) United States
(12) Patent Application Publication
(10) Pub. No.: US 2026/0029089 A1
(43) Pub. Date: Jan. 29, 2026

(54) A SYSTEM FOR CO2 STORAGE

(71) Applicant: TOTALENERGIES ONETECH, Courbevoie (FR)

(72) Inventor: Søren Mylius DAVIDSEN, Pau (FR)

(21) Appl. No.: 18/854,484

(22) PCT Filed: Apr. 7, 2022
(86) PCT No.: PCT/IB2022/000206

§ 371 Date: Oct. 4, 2024

(51) Int. Cl. F17C 1/00; E21B 41/00

(52) U.S. Cl. CPC F17C 1/007; E21B 41/0007; E21B 41/0064; F17C 2205/0352; F17C 2221/013; F17C 2223/0153; F17C 2223/035; F17C 2227/0318; F17C 2270/0128

(57) ABSTRACT

The present invention relates to a system for CO₂ storage, comprising a subsea CO₂ storage unit having at least one inlet for receiving liquid CO₂ and at least one outlet connected to at least one injection well in a subterranean reservoir, the subsea storage unit comprising at least one pipeline, the subsea storage unit being configured to contain and store CO₂ and to transfer heat from the surrounding seawater to the contained CO₂. The invention also relates to a method for CO₂ storage.

### TECHNICAL FIELD

The present invention relates to the field of CO₂ storage, and more specifically to a system for CO₂ storage, the system comprising a subsea CO₂ storage unit having at least one inlet for receiving liquid CO₂ and at least one outlet connected to at least one injection well in a subterranean reservoir, the subsea CO₂ storage unit comprising at least one pipeline, the subsea CO₂ storage unit being configured to contain and store CO₂ and to transfer heat from the surrounding seawater to the contained CO₂. The invention also relates to a method for CO₂ storage.

### TECHNICAL BACKGROUND

Carbon storage projects often make use of subterranean reservoirs of subterranean formations for depositing CO₂. Such subterranean reservoirs are often offshore and are therefore equipped with offshore oil platforms, cargo systems and/or pipelines connected to CO₂ sources on the mainland that transport and supply CO₂ to the subterranean reservoirs. The logistics of said steps of transport and supply depend heavily on offshore weather conditions and can often be obstructed when such conditions are harsh or volatile. In addition, CO₂ storages are often onshore and so can take up a lot of space as well as being aesthetically unappealing. Further, conditions of the reservoir itself can also have a backlash on the coordination of such steps. In addition, if CO₂ arrives by shuttle ship to the wellheads of the subterranean reservoirs, it is generally at a temperature that is too low for injection of the CO₂ into the subterranean reservoir to be successfully executed (for example, at approximately −26° C.), in view notably of equipment design. Therefore additional equipment is needed to condition the CO₂ before it is ready for injection.

Aspects of these difficulties have been addressed by the following documents.

GB 2470122 A relates to a subsea high-pressure liquid carbon dioxide storage equipment including a carrier for holding and carrying high-pressure liquid carbon dioxide, a water-surface power supply equipment arranged on the surface of the water to supply power, a subsea storage equipment having high-pressure liquid carbon dioxide stored therein, a relay flotation tank having high-pressure liquid carbon dioxide stored therein and an undersea injection pump configured to inject high-pressure liquid carbon dioxide into an undersea storage base and fixedly provided in the seabed. The storage equipment may comprise a buoyancy controller using seawater influx and discharge pumps to regulate the buoyancy of the storage tank. The storage installation may feature measuring units or sensors to measure the amount of liquid CO₂ and non-condensable gases in the storage space.

KR101915855 B1 relates to a system and method for injecting and treating carbon dioxide using a seawater heat source and a compression array source. Carbon dioxide is treated in accordance with injection conditions and injected into the sea by means of a seawater source of heat and a compressor as heat energy sources available on the offshore platform. A system is provided in which a predetermined treatment is performed to inject carbon dioxide reaching the top side of the marine platform, including a supply part for supplying carbon dioxide, a separator for separating carbon dioxide from the supply into liquid and gaseous carbon dioxide, a pump for pressurizing liquid carbon dioxide supplied from the separator, a compressor for pressurizing the gaseous carbon dioxide supplied from the separator, a seawater heat exchanger for heat-exchanging the liquid carbon dioxide pressurized by the pump using a seawater heat source, and a compressor array heat exchanger for heat-exchanging gas carbon dioxide passed through the compressor and liquid carbon dioxide passed through the seawater heat exchanger.

JP H0796888 A relates to storing liquid CO₂ underwater without diffusion or dissolution in the sea water, by charging and sealing the liquid CO₂ in a liquid-tight bag so as to obtain packed liquid CO₂, and by submerging the packed liquid CO₂ onto the deep-sea bottom through a vertically long pipe under the pressure of discharged air. Liquid CO₂ in a tank on a charging station is pressurized by a pressurizing pump up to about 40 atm. and is then fed to a heat-exchanger where the temperature thereof is raised up to 0° C. Then, the CO₂ is introduced into a lock hopper so as to be packed into an impermeable bag. The packed liquid CO₂ is shifted into a charge pipe which has been previously pressurized up to 40 atm, and is suspended from weights provided at both ends of a long wire by means of hooks. Then, the packed liquid CO₂ together with the weight, is lowered by about 400 m so as to reach the surface of the sea water in the charge pipe. Further, after it reaches at a depth of 300 m from the sea level, where the relationship between the specific weight of the sea water and that of the liquid CO₂ are reversed, the packed liquid CO₂ is submerged onto the sea bottom for storage.

KR 20110123056 A relates to a liquefied carbon dioxide transport vessel having an underground storage device. A liquefied carbon dioxide transport vessel having an underground storage device comprises a liquefied carbon dioxide storage tank and an underground storage device. The liquefied carbon dioxide storage tank stores liquefied carbon dioxide. The underground storage device allows an underground storage place to store the liquefied carbon dioxide. The underground storage device comprises a pressing pump. The pressing pump presses the liquefied carbon dioxide unloaded from the liquefied carbon dioxide storage tank.

Within this context, there is still a need for an improved system for CO₂ storage in an efficient and optimized manner.

### SUMMARY OF THE INVENTION

It is therefore the object of this invention to provide a system for CO₂ storage, comprising a subsea CO2 storage unit having at least one inlet for receiving liquid CO₂ and at least one outlet connected to at least one injection well in a subterranean reservoir, the subsea storage unit comprising at least one pipeline, the subsea storage unit being configured to contain and store CO₂ and to transfer heat from the surrounding seawater to the contained CO₂.

According to some embodiments, the subsea CO₂ storage unit comprises a pipe rack comprising a manifold connected to a plurality of pipeline branches.

According to some embodiments, the pipe rack has a length lying from 10 m to 250 m, preferably from 50 m to 200 m, a rack height lying between 1 m and 30 m, preferably from 10 m to 20 m, and/or a rack width lying from 10 m to 100 m, preferably from 30 m to 60 m.

According to some embodiments, the plurality of branches comprises from 10 to 500 branches, preferably from 50 to 300 branches.

According to some embodiments, the subsea CO₂ storage unit comprises spacers along the pipe rack.

According to some embodiments, the subsea CO₂ storage unit has a total pipe length lying from 10 km to 90 km, preferably from 30 km to 70 km, more preferably from 40 km to 60 km.

According to some embodiments, the diameter of the at least one pipeline lies from 50 cm to 150 cm, preferably from 70 cm to 115 cm, more preferably from 75 cm to 110 cm.

According to some embodiments, the subsea CO₂ storage unit comprises a bundled pipeline comprising at least one internal pipeline within, and fluidically connected to, an external pipeline.

According to some embodiments, the subsea CO₂ storage unit has a total expanded pipe length lying from 1 km to 50 km.

According to some embodiments, the subsea CO₂ storage unit comprises a single pipeline.

According to some embodiments, the subsea CO₂ storage unit has a total pipe length lying from 1 km to 30 km, preferably from 1 km to 25 km, more preferably from 5 km to 7 km.

According to some embodiments, the subsea storage unit lies at the bottom of the sea.

According to some embodiments, the subsea CO₂ storage unit is not horizontally disposed.

According to some embodiments, the subsea CO₂ storage unit comprises multiple inlets and/or multiple outlets.

According to some embodiments, the multiple outlets are connected to multiple injection wells.

According to some embodiments, the pressure in the subsea CO₂ storage unit lies from 3 MPa to 7 MPa, preferably from 4 MPa to 5 MPa.

According to some embodiments, the subsea CO2 storage unit contains CO₂ both in a liquid phase and in a vapor phase.

According to some embodiments, the subsea CO₂ storage unit lies at a depth lying from 10 m to 3000 m, preferably from 30 m to 300 m.

According to some embodiments, the system comprises at least one CO₂ transfer line with one end connected to an inlet of the subsea CO₂ storage unit and the other end connected to a CO₂ source, the CO₂ source being, for example, a storage unit of a shuttle ship, an onshore CO₂ storage unit or an offshore platform.

According to some embodiments, the system comprises a liquid CO₂ injection line with one end connected to a liquid CO₂ outlet of the subsea CO₂ storage unit and the other end connected to the at least one injection well.

According to some embodiments, the system comprises a vapor CO₂ injection line with one end connected to a vapor CO₂ outlet of the subsea CO₂ storage unit and the other end connected to the at least one injection well.

According to some embodiments, the system comprises a pump positioned along the liquid CO₂ injection line.

According to some embodiments, the system comprises an expansion unit along the liquid CO₂ injection line configured to convert liquid CO₂ to vapor CO₂.

According to some embodiments, the system comprises a pipeline end module connected at an inlet to the CO₂ subsea storage unit and/or at an outlet to the CO₂ subsea storage unit.

According to some embodiments, the system comprises multiple subsea CO₂ storage units.

Another object of the invention is a method for CO₂ storage, the method comprising steps of:
feeding liquid CO₂ to at least one inlet of a subsea CO₂ storage unit in a system for CO₂ storage, the subsea CO₂ storage unit comprising at least one pipeline;
containing and storing CO₂ in the subsea CO₂ storage unit;
transferring heat from the surrounding seawater to the contained CO2;
injecting CO2 from at least one outlet of the subsea CO₂ storage unit into at least one injection well of a subterranean reservoir.

According to some embodiments, the steps of feeding liquid CO₂ and injecting CO₂ are executed simultaneously.

According to some embodiments, the steps of feeding liquid CO₂ and injecting CO₂ are executed consecutively.

According to some embodiments, the pressure in the subsea CO₂ storage unit lies from 3 MPa to 7 MPa, preferably from 4 MPa to 5 MPa.

According to some embodiments, a portion of the liquid CO₂ fed to the subsea CO₂ storage unit transitions to a vapor phase within the subsea storage unit.

According to some embodiments, the liquid CO₂ is fed to the at least one inlet of the subsea CO₂ storage unit from the a CO₂ source, the CO₂ source being in the form of a pipeline connected to an onshore storage unit, the pressure of the liquid CO₂ fed to the subsea CO₂ storage unit lying from 4 MPa to 20 MPa upon entry into the subsea storage unit, preferably from 4 MPa to 15 MPa.

According to some embodiments, the liquid CO₂ is fed to the at least one inlet of the subsea CO₂ storage unit from the a CO₂ source, the CO₂ source being in the form of a CO₂ storage unit of a shuttle ship, the pressure of the liquid CO₂ fed to the subsea CO₂ storage unit upon entry into the subsea storage unit lying from 0.5 MPa to 3 MPa, preferably from 1.5 MPa to 2.5 MPa, more preferably at approximately 2 MPa, and the temperature of the liquid CO₂ fed to the subsea CO₂ storage unit lies from −20° C. to −30° C. upon entry into the subsea CO₂ storage unit, preferably from −24° C. to −28° C.

According to some embodiments, CO₂ is injected as a stream of liquid CO₂, a stream vapor CO₂ or a combination of a stream of liquid CO₂ and a stream of vapor CO₂, from the subsea CO₂ storage unit to the at least one injection well.

According to some embodiments, liquid CO₂ is collected from the subsea CO₂ storage unit and converted to vapor CO₂ before being injected into the at least one injection well.

According to some embodiments, the system for CO₂ storage is according to any of the previously described embodiments.

The present invention makes it possible to address the need mentioned above. In particular, the method provides a system for CO₂ storage which is efficient and optimized with respect to the prior art.

This is achieved by means of a subsea CO₂ storage unit. The subsea CO₂ storage is configured for the containing and storing of CO₂ prior to injection into a subterranean reservoir. This may allow for reduced onshore CO₂ storages. This also provides a reserve or buffer system for CO₂ in the event that the reservoir is not yet ready for CO₂ injection when a shuttle ship has arrived for CO₂ delivery, or in the event that direct injection from the shuttle ship or any other delivery agent (e.g. pipeline connected to the mainland, offshore platform) to the wellhead of the subterranean reservoir is undesirable.

Moreover, the subsea CO₂ storage unit is configured to transfer heat from the surrounding seawater to the contained CO₂. This enables the CO₂ to be heated to a temperature high enough to facilitate its injection into the subterranean reservoir. In addition, as a result of the heat transfer, vapor CO₂ may form towards an upper surface of the subsea CO₂ storage unit (the term “upper surface”, referring to that which is closest to the water surface) in addition to the liquid state of CO₂ present in the rest of the subsea CO₂ storage unit. This in turn allows for vapor CO₂ to be outputted from the subsea CO₂ storage unit for injection into the subterranean reservoir in addition to the heated liquid CO₂.

The system may therefore allow for a system that can together store and condition liquid CO₂. As a result, the system may not require additional heaters for the system, simplifying the system while also reducing energy costs.

Advantageously and according to some embodiments, the subsea CO₂ storage unit comprises a pipe rack, a bundled pipeline or a single pipeline to provide sufficient containment and storage of the CO₂ and to improve the heat transfer between the CO₂ and the seawater.

### BRIEF DESCRIPTION OF THE DRAWINGS

Non-limiting examples will now be described in reference to the accompanying drawings, where:

FIG. 1 shows an illustration of the system according to an embodiment.

FIG. 2 shows an illustration of the system according to an embodiment.

FIG. 3 shows an illustration of the system according to an embodiment.

FIG. 4 shows an illustration of phase transition of CO₂ in the subsea CO₂ storage unit according to an embodiment.

FIG. 5a shows an illustration of the system according to an embodiment, with multiple subsea CO₂ storage units comprising pipe racks.

FIG. 5b shows an illustration of the system according to an embodiment, with multiple subsea CO₂ storage units comprising bundled pipelines.

FIG. 5c shows an illustration of the system according to an embodiment, with multiple subsea CO₂ storage units comprising single pipelines.

FIG. 6 shows a schematic illustration of a countercurrent in a subsea CO₂ storage unit according to an embodiment.

FIG. 7 shows a schematic illustration of the system according to an embodiment.

### DETAILED DESCRIPTION

The invention will now be described in detail without limitation in the following description.

The system of the present invention comprises a subsea CO₂ storage unit comprising at least one pipeline, and having at least one inlet for receiving liquid CO₂ and at least one outlet connected to at least one injection well in a subterranean reservoir. A “subsea” CO₂ storage unit refers to a CO₂ storage unit that is submerged underwater, or more specifically, that is submerged in the waters of a sea or ocean. In other words, the entire CO₂ storage unit is below the water surface. A “CO₂ storage unit” refers to a device that is used for containing and/or storing CO₂ for a period of time. Such a period of time may be equal to or greater than that over which the CO₂ needs to be heated to a desired temperature by the surrounding seawater. A subsea CO₂ storage unit configured to “contain” CO₂ refers to the holding of CO₂ inside the subsea CO₂ storage unit. A subsea CO₂ storage unit configured to “store” CO₂ refers to the holding of CO₂ inside the subsea CO2 storage unit for a future use. A subsea CO₂ storage unit configured to “transfer heat from the surrounding seawater to the contained CO₂” refers to the heat transfer from the surrounding seawater, through one or more walls of the subsea CO₂ storage unit and to the contained CO₂ by means of convection and conduction. The storage of the CO₂ in the CO₂ storage unit is transient, as the CO₂ is ultimately injected into the subterranean reservoir.

A “subterranean reservoir” refers to a hydrocarbon reservoir within a subterranean formation. The reservoir may be positioned offshore and found at a depth below sea level that is, for example, greater than 1 km such as from 2 km to 4 km or of such order. This hydrocarbon reservoir may be partly, substantially or fully depleted—i.e. the hydrocarbons in the reservoir may have been previously produced at the time the system of the invention is implemented. A reservoir is an underground portion wherein a fluid such as CO₂ or hydrocarbons can be contained without substantially diffusing to neighboring portions. In this respect, the reservoir can be considered as a geological enclosure within a subterranean formation. For example, the neighboring portions may be made of rock material having a lower porosity than the rock material of the reservoir itself. In some variations, a layer of clay may be present above the reservoir. In some variations, a water-containing layer may be present below the reservoir. In some variations, the reservoir may be partly delimited by a crack creating a porosity discontinuity through which a fluid may not easily flow. The reservoir may be of an elongated shape, with for example, a height of from 20 to 300 m and/or a lateral dimension of from 2 km to 15 km, for example from 3 to 10 km.

An “injection well” refers to a well that is used to inject CO₂ into a subterranean reservoir. This well may be a dry well, or in other words a well placed on a platform. Alternatively, this well may be a wet well, or in other words a well placed on a subsea template.

Different embodiments of the present invention are described below. Some embodiments disclose the system with the subsea CO₂ storage unit comprising a pipe rack.

Other embodiments disclose the system with the subsea CO₂ storage unit comprising a bundled pipeline.

Other embodiments disclose the system with the subsea CO₂ storage unit comprising a single pipeline.

### General Principle

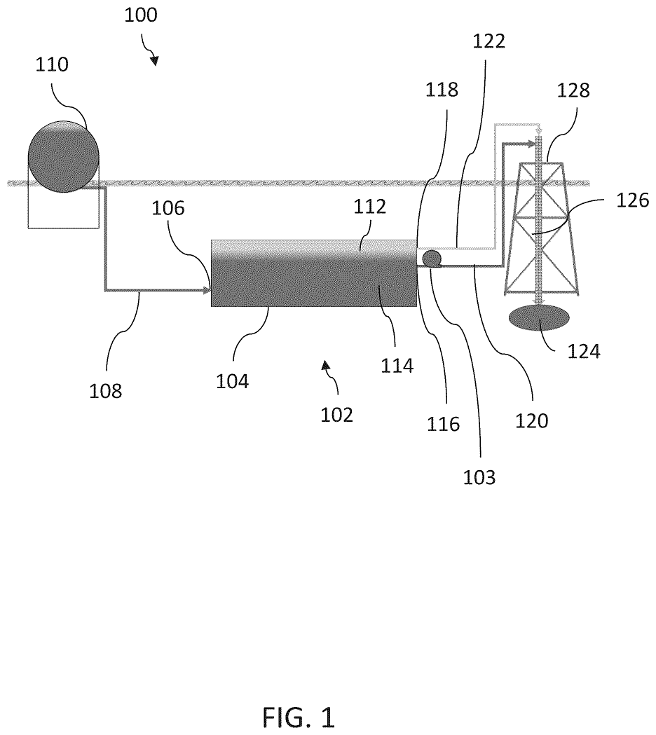

FIG. 1 displays a general illustration of the system for CO₂ storage 100 according to an embodiment wherein the system for CO₂ storage 100 comprises a subsea CO₂ storage unit 102 comprising at least one pipeline 104. The subsea CO₂ storage unit 102 may be fed liquid via an inlet 106. The inlet 106 may be connected to one end of a transfer line 108 that may supply the liquid CO₂ from a CO₂ source 110 such as, for example, a CO₂ storage unit of a shuttle ship or offshore platform to which the other end of the transfer line 108 is connected. The transfer line 108 may be connected to the storage unit of the offshore platform via a connection unit, such as, for example, a loading buoy. The transfer line 108 may for example be in the form of a flexible riser. Additionally or alternatively, the CO₂ transfer line 108 may be connected to another CO₂ source 110, such as, for example, an onshore storage unit, from which it may feed the liquid CO₂ to the inlet 106. The transfer line 108 may be connected to the storage unit of the onshore storage unit via a connection unit, such as, for example, an onshore terminal.

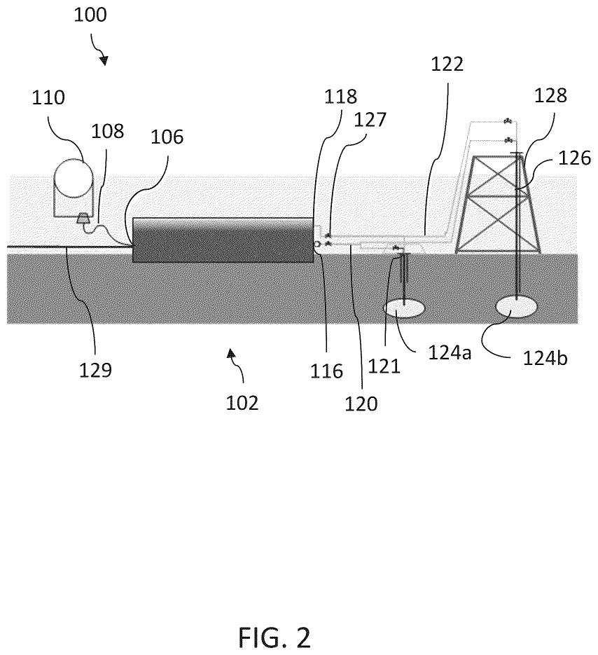

As illustrated in FIG. 2, a pipeline 129 connected to the onshore storage unit may be connected directly at one end to the transfer line 108. Alternatively, the pipeline 129 connected to an onshore storage unit may be tapped at a point along its length for connection to the transfer line 108, the end of the pipeline 129 bypassing the subsea CO₂ storage unit and continuing to provide CO₂ to at least one injection well 126 of a subterranean reservoir 124a, 124b. According to some embodiments, liquid CO₂ may be supplied from a shuttle ship via an offshore platform positioned on the at least one injection well 126, or via a dedicated riser. The shuttle ship may feed liquid CO₂ via the transfer line 108 (such as for example a cryogenic flexible line) to the offshore platform or riser with the assistance of a tower loading unit. In other words, the offshore platform or the riser may be used as an intermediary point between the shuttle ship and the subsea storage unit 102. Some or all of the supplied CO₂ may then be diverted through the offshore platform via the transfer line 108 to the subsea storage unit 102. After the CO₂ is diverted towards the riser with the assistance of a tower loading unit, CO₂ may be pumped through the transfer line 108 to the subsea storage unit 102.

Alternatively, multiple transfer lines 108 connected to the same or different CO₂ sources 110 may be simultaneously connected to multiple inlets 106 of the subsea CO₂ storage unit 102 to feed different streams of CO₂ to the subsea CO₂ storage unit 102. For example, a supply of liquid CO₂ may be fed from the pipeline 129 connected to an onshore storage unit to an inlet 106 while liquid CO₂ is simultaneously being fed from a shuttle ship via another transfer line 108 connected to an inlet 106.

Referring again to FIG. 1, the subsea CO₂ storage unit 102 may contain and store the CO₂ in the subsea CO₂ storage unit 102. The subsea CO₂ storage unit 102 is preferably at a fixed position relative to the bottom of the sea. The subsea CO₂ storage unit 102 may be horizontally disposed. According to some embodiments, the subsea CO₂ storage unit 102 may lie at the bottom of the sea. Alternatively, the subsea CO₂ storage unit may have sea water surrounding the entire subsea CO₂ storage unit 102, the subsea CO₂ storage unit 102 floating at a certain depth from the water surface.

The transfer line 108 feeds the liquid CO₂ into the subsea CO₂ storage unit 102 at a temperature depending on the pressure within the CO₂ source 110. By way of example, this temperature may lie between −20° C. and −30° C. upon entry into the subsea CO₂ storage unit 102, preferably between −24° C. and −28° C., by way of illustration at approximately −26° C.

The surrounding seawater may be of a temperature lying from 0° C. to 30° C., or for example from 5° C. to 20° C. and may transfer heat to the liquid CO₂ contained within the subsea CO₂ storage unit 102 so that it reaches approximately the same temperature.

The subsea CO₂ storage unit 102 comprises one or more pipelines 104. Each pipeline 104 may have an internal surface area of, for example, 5 m² or less, preferably from 2 m² to 5 m² per cubic meter of internal volume. If the pipelines 104 have a cylindrical shape with a circular cross-section, the internal diameter of the pipelines 104 may for example range from 50 cm to 2 m. The internal volume of the subsea CO₂ storage unit 102 available for CO₂ storage may lie from 1,000 m³ to 100,000 m³, preferably from 2,500 m³ to 75,000 m³, more preferably from 5,000 m³ to 50,000 m³. The pipelines 104 may comprise or be made of steel, such as, for example, carbon steel, or alloy steel.

Preferably, the subsea CO₂ storage unit 102, once in use, contains substantially only CO₂ and no other substance (such as in particular seawater).

According to some embodiments, CO₂ in the CO₂ storage unit of a shuttle ship, and upon entry into the subsea CO₂ storage unit 102, may be at a pressure lying from 0.5 MPa to 3 MPa, preferably lying from 1.5 MPa to 2.5 MPa, more preferably at approximately 2 MPa, when the transfer line 108 feeds the liquid CO2 into the subsea CO2 storage unit 102 at a temperature lying from −20° C. to −30° C. upon entry into the subsea CO2 storage unit 102, preferably lying from −24° C. to −28° C. According to other embodiments, CO₂ in the pipeline 129 connected to an onshore storage unit, and upon entry into the subsea CO₂ storage unit 102, may be at a pressure lying from 4 MPa to 20 MPa, preferably lying from 4 MPa to 15 MPa. In some variations, a pressure reduction valve may be provided at or upstream of the inlet of the CO₂ storage unit 102. The CO₂ in the subsea CO₂ storage unit 102 may experience a pressure increase owing to the static pressure within the subsea CO₂ storage unit 102.

As a result, the CO₂ not only experiences a heat transfer conditioning step of temperature increase, but may also experience a pressure conditioning step in preparation for injection into the subterranean reservoir 124.

The subsea CO₂ storage unit 102 may contain CO₂ both in a liquid phase 114 and in a vapor phase 112 as a portion of the liquid CO₂ may transition to a vapor phase within the subsea CO₂ storage unit 102 as a result of the heat transfer and pressure conditions of the subsea CO₂ storage unit 102.

The pressure in the subsea CO₂ storage unit 102 (especially after a period of storage time) may lie, for example, from 3 MPa to 7 MPa, preferably from 4 MPa to 5 MPa, more preferably at approximately 4 MPa. After a period of storage time, liquid CO₂ may be at equilibrium with vapor CO₂ within the subsea CO₂ storage unit 102; in that case, the pressure within the subsea CO₂ storage unit 102 depends on the temperature in the unit, which is itself preferably approximately equal to the surrounding sea temperature.

The vapor CO₂ 112 may be in an upper portion of the subsea CO₂ storage unit 102, (i.e. a portion which is closer to the water surface than the rest of the unit). According to some embodiments, the subsea CO₂ storage may not be horizontally disposed, especially if it lies on a portion of the sea bottom which is sloped. In this instance, vapor CO₂ may occupy an upper portion of the subsea CO₂ storage unit 102 that is elevated relative to the rest of the subsea CO₂ storage unit 102.

The subsea CO₂ storage unit 102 may comprise at least one outlet. The subsea CO₂ storage unit 102 may indeed comprise multiple outlets. The multiple outlets may be connected to one injection well. Additionally or alternatively, the multiple outlets may be connected to multiple injection wells. The subsea CO₂ storage unit 102 may inject liquid CO₂ from at least one liquid outlet 116 of the subsea CO₂ storage unit 102 (preferably positioned in a lower portion of the subsea CO₂ storage unit 102) into the at least one injection well 126 of the subterranean reservoir 124 via a CO₂ liquid injection line 120 with one end connected to a liquid CO₂ outlet 116 of the subsea CO₂ storage unit 102 and the other end connected to the at least one injection well 126. A pump 103 may be positioned along the liquid injection line 120 to facilitate injection into the subterranean reservoir 124. An expansion unit (not shown) may be positioned along the liquid CO₂ injection line 120 and, upon collection of liquid CO₂ by the liquid CO₂ injection line 120, may convert part or all of the liquid CO₂ to vapor CO₂ before being injected into the at least one injection well 126. To facilitate connection between the transfer line 108 and/or injection lines 120, 122, the system for CO₂ storage 100 may comprise a pipeline end module (not shown) connected at an inlet to the CO₂ subsea storage unit and/or at an outlet to the CO₂ subsea storage unit.

The subsea CO₂ storage unit 102 may inject vapor CO₂ from at least one vapor outlet 118 of the subsea CO₂ storage unit 102 (preferably positioned in an upper portion of the subsea CO₂ storage unit 102) into at least one injection well 126 of a subterranean reservoir 124 via a CO₂ vapor injection line 122 with one end connected to a vapor CO₂ outlet 118 of the subsea CO₂ storage unit 102 and the other end connected to the at least one injection well 126. In an advantageous embodiment, no compressor is provided on the CO₂ vapor injection line 122, as the pressure within the CO₂ storage unit 102 is sufficient to effect the injection of vapor CO₂.

As demonstrated in FIG. 2, the CO₂ liquid injection line 120 and/or the CO₂ vapor injection line 122 may be entirely underwater and may be directly connected to the subsea wellhead 121 of a subterranean reservoir 124a. Additionally or alternatively, the CO₂ liquid injection line 120 and/or the CO₂ vapor injection line 122 may be connected to an injection well 126 via a rigid riser 128 of an offshore platform above the water surface, and injection to a subterranean reservoir 124b may be executed via the rigid riser 128.

Each CO₂ injection line, and especially the CO₂ liquid injection line 120 and/or the CO₂ vapor injection line 122 if present, may be provided with at least one closable valve 127, in order to control whether CO₂ is injected or not, and optionally in order to control the flow rate of the CO₂ in the respective injection line.

According to some embodiments, steps of feeding liquid CO₂ to the system for CO₂ storage 100 and injecting CO₂ from the subsea CO₂ storage unit 102 into the subterranean reservoir 124a, 124b may be executed simultaneously. In other words, while liquid CO₂ is being fed into the subsea CO₂ storage unit 102, liquid CO₂ and/or vapor CO₂ may be also injected from one or multiple outlets 116, 118 of the subsea CO₂ storage unit 102. During simultaneous feeding and injecting, average residence time of CO₂ within the subsea CO₂ storage unit 102 may by of example range from 3 to 12 hours.

The subsea CO₂ storage unit 102 may experience pressure fluctuations over the course of CO₂ feeding and CO₂ injection, for example lying from 100 kPa to 200 kPa or of such order.

Alternatively, steps of feeding liquid CO₂ to the system for CO₂ storage 100 and injecting CO₂ from the subsea CO₂ storage unit 102 into the subterranean reservoir 124a, 124b may be executed consecutively. In other words, the reservoir 124a, 124b may remain filled or partly filled during a certain period of time after feeding of liquid CO₂ into the subsea CO₂ storage unit 102, before injection into a subterranean reservoir 124a, 124b begins. Such a duration may be a short term pause, such as for example from 1 day to 7 days, or from 24 hours to 72 hours, or from 1 hour to 24 hours. Alternatively, such a duration may last for a number of weeks, such as for example less than two weeks, or from two weeks to one month. Alternatively, such a duration may last several months, such as from 1 to 6 months, or from 6 to 12 months, or from 12 to 18 months. Such a duration may indeed last for several years, such as less than five years, or more than five years, or less than 10 years, or more than 10 years. In this case, the subsea CO₂ storage unit 102 acts as a buffer between feeding and injection.

These consecutive steps may for example be advantageous to ensure that the CO₂ is properly conditioned to the desired temperature in the subsea CO₂ storage unit 102.

Alternatively, steps of simultaneous feeding and injection may alternate with steps of only feeding or only injection. Additionally or alternatively, steps of simultaneous feeding and injection may include pauses without feeding and injection. By way of example, CO₂ injection into the subterranean reservoir 124a, 124b may be carried out substantially continuously, while CO₂ feeding to the subsea CO₂ storage unit 102 may be carried out intermittently. In this case, the flow rate of CO₂ injection is lower than the flow rate of CO₂ feeding to the subsea CO₂ storage unit 102. This may be advantageous especially when CO₂ is fed to the subsea CO₂ storage unit 102 by shuttle ships, and thus necessarily in a discontinuous manner.

The pressure within the subsea CO₂ storage unit 102 may remain constant or relatively constant throughout the course of feeding into the subsea CO₂ storage unit 102 and injecting the CO₂ from the subsea CO₂ storage unit 102 into the subterranean reservoir 124a, 124b. The subsea CO₂ storage unit 102 may lie at a depth lying from 10 m to 3000 m, preferably from 30 m to 300 m.

According to some embodiments, CO₂ may be injected, as a stream of liquid CO₂, a stream of vapor CO₂ or a combination of a stream of liquid CO₂ and a stream of vapor CO₂, from the subsea CO₂ storage unit 102 to the at least one injection well 126. The CO₂ injected into the subterranean reservoir 124a, 124b may therefore be a single-phase or two-phase mixture.

According to some embodiments, the subsea CO₂ storage unit 102 may comprise a pipe rack. Alternatively, and according to some embodiments, the subsea CO₂ storage unit 102 may comprise a bundled pipeline comprising at least one internal pipeline within, and fluidically connected to, an external pipeline. Alternatively, and according to some embodiments, the subsea CO₂ storage unit 102 may comprise a single pipeline.

### Pipe Rack

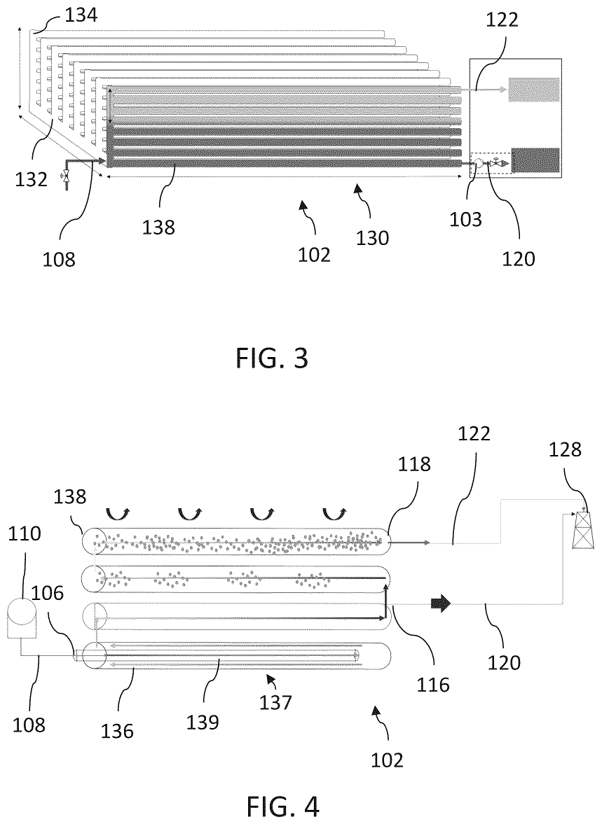

FIG. 3 to FIG. 5a relate to examples of subsea CO₂ storage units comprising a pipe rack 130. Regarding FIG. 3, the pipe rack 130 comprises a manifold 132 connected to a plurality of pipeline branches 138. The pipeline branches 138 may extend substantially parallel to each other, and may form a two-dimensional, or, as illustrated, three-dimensional array. In this example, the manifold 132 comprises (e.g. 8) prongs 134 which are horizontally spaced from each other. Each prong 134 is connected to (e.g. 8) branches 138 which are vertically spaced from each other. The plurality of branches 138 may comprise a total of from 10 to 500 branches 138, preferably from 50 to 300 branches 138. Spacing between the branches 138 may be selected to be of certain dimensions, for example, from 0.1 m to 1 m, so as to optimize heat transfer across the pipe rack.

The pipe rack 130 may optionally be provided with an external and/or internal frame to hold the branches 138 (not shown). The subsea CO₂ storage unit 102 may comprise spacers (not shown) along the pipe rack 130 to allow for thermal expansion of the branches 138. The spacers may be positioned perpendicularly to the branches 138.

Each pipeline branch 138 may be closed at the end opposite the manifold 132. Alternatively, the pipe rack 130 may comprise a second manifold connected to the pipelines branches, at the extremity thereof opposite the manifold 132. In this case, the pipeline branches 138 extend between the two manifolds. The pipe rack 130 may have a length lying from 10 m to 250 m, preferably from 50 m to 200 m, a rack height lying from 1 m to 30 m, preferably from 10 m to 20 m, and/or a rack width lying from 10 m to 100 m, preferably from 30 m to 60 m. The length of the pipe rack 130 may correspond to the length of the branches 138 extending from the manifold 132 (the total pipe length within the pipe rack 130 may be much larger, since the pipe rack 130 may comprise a large number of pipeline branches, for example, the subsea CO₂ storage unit may have a total pipe length lying from 10 km to 90 km, preferably from 30 km to 70 km, more preferably from 40 km to 60 km).

In view of the relatively short length of the pipe rack 130 (in comparison with the other embodiments described below), the pipe rack may often be considered as lying in a substantially horizontal manner on the sea bottom, as the sea bottom slope can be neglected.

The diameter of the pipeline branches may lie from 50 cm to 150 cm, preferably from 70 cm to 115 cm, more preferably from 75 cm to 110 cm. The pipe rack 130 may for example have a total volume lying from 1000 m³ to 10,000 m³, preferably from 2500 m³ to 75,000 m³, more preferably from 5000 m³ to 50,000 m³. The ratio of vapor CO₂ to liquid CO₂ in the subsea CO₂ storage unit 102 may vary over time. The subsea CO₂ storage unit may, for example, where steps of providing liquid CO₂ to the system for CO₂ storage and injecting CO₂ from the subsea CO₂ storage unit 102 into the subterranean reservoir 124 may be executed consecutively, have a liquid fraction lying from 00% to 100%, for example from 70% to 80%, or for example at approximately 75% by weight; at the beginning of the injection step. According to such an embodiment, during injection the liquid fraction in the subsea CO₂ storage unit may decrease.

The pipe rack 130 may comprise upper branches 138 containing CO₂ vapor and lower branches 138 containing liquid CO₂. The boundary between the vapor CO₂ and liquid CO₂ may move over time as the vapor to liquid CO₂ weight ratio in the pipe rack 130 changes. Vapor CO₂ may be injected to the wellhead of a subterranean reservoir 124 via a vapor CO₂ outlet in one or more of the upper branches 138. Likewise, liquid CO₂ may be injected via a liquid CO₂ outlet in one or more of the lower branches 138 to the wellhead of a subterranean reservoir 124. In FIG. 4, liquid and vapor CO₂ are both injected to the wellhead via a rigid riser 128.

### Bundled Pipeline

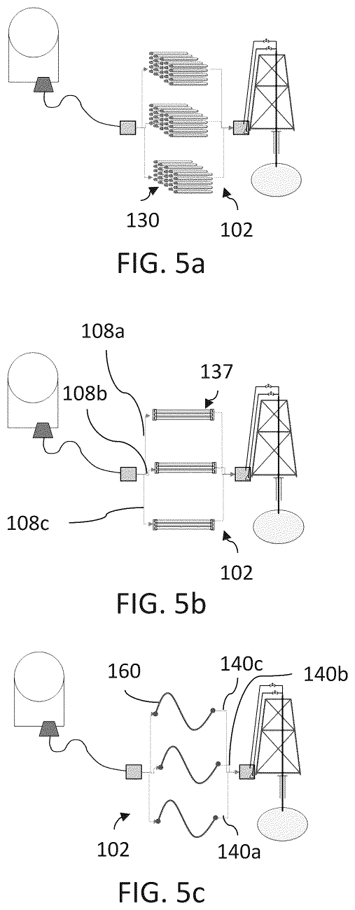

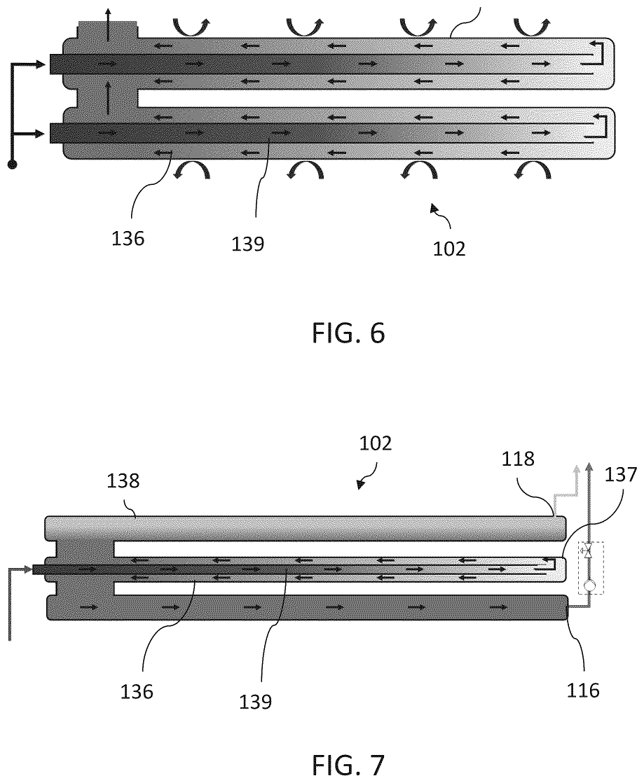

FIG. 4, FIG. 5b, FIG. 6 and FIG. 7 relate to examples of subsea storage units comprising at least one bundled pipeline 137. The bundled pipeline 137 may comprise at least one internal pipeline concentrically arranged within, and fluidically connected to, an external pipeline. This may make it possible to optimize heat transfer owing internal heat exchange of the CO₂ against itself. In particular, the CO₂ may flow in a countercurrent manner in the internal pipeline and external pipeline.

More than one bundled pipelines 137 may be connected together, in series or in parallel.

The subsea CO₂ storage unit 102 may also comprise one or more (non-bundled) pipelines in addition to, and fluidically connected the bundled pipeline(s) 137.

As shown in FIG. 4, the subsea CO₂ storage unit 102 may comprise an inlet 106 connected to a lower bundled pipeline 137, which is itself fluidically connected to a plurality of pipeline branches 138 extending substantially horizontally above the lower bundled pipeline and for example vertically spaced from each other. CO₂ may flow first in the bundled pipeline 137 (for example, first the internal pipeline 139 and second in the external pipeline 136); and then in the pipeline branches 138. The pipeline branches 138 may comprise a lower portion containing liquid CO₂ and an upper portion containing vapor CO₂. The flow path may run from the bundled pipeline 137 to the lower portion and then to the upper portion. A liquid outlet 116 may be connected to the lower portion, and a vapor outlet 118 may be connected to the upper portion.

As CO₂ travels within the subsea CO₂ storage unit 102, the surrounding seawater (at a temperature of for example approximately 5° C.) heats the CO₂ through the walls of the bundled pipeline 137 and pipeline branches 138. During feeding, the temperature of the CO₂ within the subsea CO₂ storage unit 102 may not be uniform. By way of example, the temperature of the CO₂ may increase up to approximately 0° C. along the internal pipeline 139 of the bundled pipeline 137, and then up to approximately 2 to 4° C. along the external pipeline 136 of the bundled pipeline 137. The temperature of the CO₂ may reach for example approximately 5° C. in one or more of the pipeline branches 138 downstream of the bundled pipeline 137. The temperature within the subsea CO₂ storage unit 102 may be uniform when there is no step of feeding. Additionally (i.e. at another point in time) or alternatively, the temperature within the subsea CO₂ storage unit 102 may not be uniform when there is no step of feeding, such as for example during a period immediately after which feeding has been completed.

In some variants, and as shown in FIG. 7, the external pipeline 136 of a bundled pipeline may be connected to at least two pipeline branches 138, one below the bundled pipeline 137, and the other above the bundled pipeline 137. A liquid outlet 116 may be connected to the pipeline branch 138 below the bundled pipeline 137, and a vapor outlet 118 may be connected to the pipeline branch above the bundled pipeline 137.

As shown in FIG. 6, the subsea CO₂ storage unit 102 may comprise at least two bundled pipelines 137 which may be fluidically connected, and possibly disposed in parallel, such as vertically spaced. CO₂ may be fed to the internal pipelines 139 of bundled pipelines 137 and the external pipelines 136 may be fluidically connected together, as shown.

According to some embodiments, the bundled pipeline(s) may have a total expanded pipe length (internal pipe and external pipe) preferably lying from 1 km to 15 km, preferably from 5 km to 10 km, more preferably from 5 km to 7 km. When one or more non-bundled pipelines are connected to the bundled pipeline(s), the total expanded pipe length of the subsea CO₂ storage unit 102 may lie for example from 1 km to 50 km.

### Single Pipeline

Referring to FIG. 5c, the subsea CO₂ storage unit 102 may comprise a single pipeline 160. Like with the bundled pipeline, according to some embodiments, the subsea CO₂ storage unit 102 may have a total length lying from 1 km to 30 km, preferably from 1 km to 25 km, more preferably from 5 km to 7 km. An outlet positioned at one end of the single pipeline 160 may inject a one-phase liquid CO₂ injection only. The liquid may be expanded to a vapor CO₂ upon leaving the outlet.

### Multiple Pipelines

The system may comprise multiple subsea CO₂ storage units 102, using any combination of said embodiments. Referring to FIG. 5a to FIG. 5c, the system for CO₂ storage comprises multiple subsea storage units comprising pipe racks 130 (FIG. 5a) or multiple bundles pipelines 137 (FIG. 5b) or multiple single pipes 160 (FIG. 5c). Liquid CO₂ may be delivered via a common transfer line 108 to individual transfer lines 108a, 108b, 108c dedicated to each to each of the multiple subsea storage units. Liquid CO₂ may flow through an outlet of each pipe rack 130/bundled pipeline 137/single pipeline 160, each pipe rack 130/bundled pipeline 137/single pipeline 160 being connected to its own liquid CO₂ injection line and/or own vapor CO₂ injection line 140a, 140b, 140c. Each CO₂ vapor injection line or CO₂ liquid injection line 140a, 140b, 140c may be used independently. Alternatively, at least two of the injection lines may provide CO₂ to one common injection line 120, before the CO₂ is injected into the at least one injection well 126 of a subterranean reservoir 124.

In addition, and independently, a subsea CO₂ storage unit 102 may comprise a pipe rack 130 and a bundled pipeline 137, or a pipe rack 130 and a single pipeline 160, or a bundled pipeline 137 and a single pipeline 160, which may be serially fluidically connected.

Furthermore, a pipe rack 130 may comprise one or more bundled pipelines 137 as part or all of the branches 138 described above.

1. A system for CO₂ storage, comprising a subsea CO₂ storage unit having at least one inlet for receiving liquid CO₂ and at least one outlet connected to at least one injection well in a subterranean reservoir, the subsea storage unit comprising at least one pipeline, the subsea storage unit being configured to contain and store CO₂ and to transfer heat from the surrounding seawater to the contained CO₂.

2. The system according to claim 1, wherein the subsea CO₂ storage unit comprises a pipe rack comprising a manifold connected to a plurality of pipeline branches.

3-4. (canceled)

5. The system according to claim 2, wherein the subsea CO₂ storage unit comprises spacers along the pipe rack.

6-7. (canceled)

8. The system according to claim 1, wherein the subsea CO₂ storage unit comprises a bundled pipeline comprising at least one internal pipeline within, and fluidically connected to, an external pipeline.

9. (canceled)

10. The system according to claim 1, wherein the subsea CO₂ storage unit comprises a single pipeline.

11. (canceled)

12. The system according to claim 1, wherein the subsea storage unit lies at the bottom of the sea.

13. The system according to claim 10, wherein the subsea CO₂ storage unit is not horizontally disposed.

14. The system according to claim 1, wherein the subsea CO₂ storage unit comprises multiple inlets and/or multiple outlets.

15-16. (canceled)

17. The system according to claim 1, wherein the subsea CO₂ storage unit contains CO₂ both in a liquid phase and in a vapor phase.

18. (canceled)

19. The system according to claim 1, comprising at least one CO₂ transfer line with one end connected to an inlet of the subsea CO₂ storage unit and the other end connected to a CO₂ source.

20. The system according to claim 1, comprising a liquid CO₂ injection line with one end connected to a liquid CO₂ outlet of the subsea CO₂ storage unit and the other end connected to the at least one injection well.

21. The system according to claim 1, comprising a vapor CO₂ injection line with one end connected to a vapor CO₂ outlet of the subsea CO₂ storage unit and the other end connected to the at least one injection well.

22. (canceled)

23. The system according to claim 1, comprising an expansion unit along the liquid CO₂ injection line configured to convert liquid CO₂ to vapor CO₂.

24. The system according to claim 1, comprising a pipeline end module connected at an inlet to the CO₂ subsea storage unit and/or at an outlet to the CO₂ subsea storage unit.

25. (canceled)

26. A method for CO₂ storage, the method comprising steps of:
feeding liquid CO₂ to at least one inlet of a subsea CO₂ storage unit in a system for CO₂ storage, the subsea CO₂ storage unit comprising at least one pipeline;
containing and storing CO₂ in the subsea CO₂ storage unit;
transferring heat from the surrounding seawater to the contained CO₂;
injecting CO₂ from at least one outlet of the subsea CO₂ storage unit into at least one injection well of a subterranean reservoir.

27-29. (canceled)

30. The method according to claim 26, wherein a portion of the liquid CO₂ fed to the subsea CO₂ storage unit transitions to a vapor phase within the subsea storage unit.

31. The method according to claim 26, wherein the liquid CO₂ is fed to the at least one inlet of the subsea CO₂ storage unit from a CO₂ source, the CO₂ source being in the form of a pipeline connected to an onshore storage unit, the pressure of the liquid CO₂ fed to the subsea CO₂ storage unit lying from 4 MPa to 20 MPa upon entry into the subsea storage unit.

32. The method according to claim 26, wherein the liquid CO₂ is fed to the at least one inlet of the subsea CO₂ storage unit from a CO₂ source, the CO₂ source being in the form of a CO₂ storage unit of a shuttle ship, the pressure of the liquid CO₂ fed to the subsea CO₂ storage unit upon entry into the subsea storage unit lying from 0.5 MPa to 3 MPa and the temperature of the liquid CO₂ fed to the subsea CO₂ storage unit lies from −20° C. to −30° C. upon entry into the subsea CO₂ storage unit.

33. The method according to claim 26, wherein CO₂ is injected as a stream of liquid CO₂, a stream of vapor CO₂ or a combination of a stream of liquid CO₂ and a stream of vapor CO₂, from the subsea CO₂ storage unit to the at least one injection well.

34. The method according to claim 26 wherein liquid CO₂ is collected from the subsea CO₂ storage unit and converted to vapor CO₂ before being injected into the at least one injection well.

35. (canceled)
